(19) United States
(12) Patent Application Publication
(10) Pub. No.: US 2026/0219408 A1
(43) Pub. Date: Jul. 30, 2026

(54) METHOD FOR MONITORING A POINT OF INTEREST IN A SUBSOIL

(71) Applicant: SPOTLIGHT, PARIS (FR)

(72) Inventors: Habib Al Khatib, Paris (FR); Jean-Luc Mari, Chatou (FR); Elodie Morgan, Saint-Maur-des-Fosses (FR)

(73) Assignee: SPOTLIGHT, PARIS (FR)

(21) Appl. No.: 19/147,167

(22) PCT Filed: Dec. 21, 2023
(86) PCT No.: PCT/EP2023/087227

§ 371 Date: Jul. 10, 2025

(30) Foreign Application Priority Data
Jan. 13, 2023 (FR) FR2300361

(51) Int. Cl. G01V 1/30

(52) U.S. Cl. CPC G01V 1/308; G01V 2210/6122

(57) ABSTRACT

The present invention relates to a method for monitoring an area of interest in a subsoil comprising a point of interest, the method comprising:•extracting a first subset (I) of raw geophysical data that are associated with the point of interest from among a set (0) of previously acquired raw geophysical data to generate a first image (hnl) of the subsoil;•constructing a projection model (MODI) on the basis of the first subset of data (I);•reducing the first subset (I) of data to a second subset (2);•creating a reference set (B) by applying the projection model (MODI);•carrying out an acquisition forming a third subset (3);•creating a monitoring set (M) by applying the projection model (MODI);•comparing the first reference set (B) and the first monitoring set (M) to identify a change in the subsoil to be monitored.

### TECHNICAL FIELD

The present invention is related to the field of acquiring and processing geophysical data.

More specifically, the application concerns methods to monitor an area of interest of a subsurface based on geophysical data.

### STATE OF THE ART

From prior art, it is known that the acquisition of geophysical data can be used to generate an image of the geophysical structure of a terrestrial or marine subsurface. This image helps a person skilled in the art determine the existence or absence of the area of interest with a high degree of certainty, for example, the existence or absence of natural resources.

Devices configured to generate images of a subsurface generally comprise a plurality of sources capable of producing seismic waves over different frequency ranges. These seismic waves propagate within a subsurface and an area of interest, which reflects part of the aforesaid seismic waves towards a receiver. By studying the variations in the propagation of the reflected waves in the subsurface, it is therefore possible to produce an image of the subsurface under analysis.

This standard state of the art techniques can be used at recurring intervals over time, to generate a series of images of the subsurface, so that the evolution of the geophysical profile of this subsurface can be determined and monitored. This image is called 4D, that is to say, an image of a subsurface volume evolving over time. At present, 4D study solutions are designed to fully update a 3D acquisition of the subsurface for a given area. In other words, the volume of seismic data to obtain a new complete 3D image. As a result, the current techniques take a lot of time, from several weeks to several months of computer processing of a substantial volume of data, on the order of several gigabits to several terabits of data.

4D studies are still costly in terms of resources, particularly with regard to software resources considering the massive influx of data to be processed, which takes a long time, because 4D images acquired at different calendar periods have to be generated and an evolution of the geophysical structure of an area of interest has to be determined.

The applicant previously proposed making various improvements to the known state of the art techniques, in particular to reduce the costs of financial, material, and software resources of such devices, for example by coming up with a method to identify the ideally positioned receivers among a set of sources and a set of receivers, to measure an evolution of the geophysical structure in the area of interest.

Despite these acquisition improvements, the raw recording of acquired geophysical data might require a specific processing phase to extract geophysical data that is useful for monitoring.

The invention aims to overcome the disadvantages of the state of the art by providing a method to extract useful geophysical data for an operation to monitor a subsurface that has to be monitored.

### SUMMARY

More precisely, the invention relates to a method to monitor at least one area of interest of a subsurface that has to be observed comprising a point of interest and neighbourhood of this point of interest, comprising:
an extraction of a first subset of raw geophysical data associated with the neighbourhood of the point of interest, among a set of raw geophysical data acquired previously, and processed beforehand to generate the first previous image of the subsurface to be monitored;
a construction of the first projection model from the first subset of data, the first projection model is a result of the segregation of geophysical data, to extract useful geophysical data used while the first image in the neighbourhood of the point of interest is being generated; and
a reduction of the first subset of data to a second subset comprising a predetermined minimal number of raw geophysical data;
the creation of the first reference set of useful geophysical data by applying the first projection operator to the second subset, the first projection operator is configured so that the first correlation coefficient between the first reference set of useful geophysical data obtained and the first projection model is greater than 0.7;
an acquisition of raw geophysical data to form a third subset of raw geophysical data comprising the same minimal number of raw geophysical data as the second subset, each piece of data of the third subset corresponding to a piece of data from the second subset;
the creation of the first set of useful monitoring geophysical data, by applying the first same projection operator from the first projection model, to the third subset;
a comparison of the first reference set and the first monitoring set to identify an evolution of the subsurface to be observed.

The notion of “neighbourhood” of the point of interest is defined as being an area that corresponds to the resolution of the image generated by the geophysical method used at the point of interest. For example, if the geophysical method is a seismic method, the resolution is commonly evaluated at a quarter of the wavelength, the wavelength being a function of the wave propagation speed in the geological formations and the dominant frequency of the recorded signal.

As a result of this combination of features, an evolution of the geophysical response of the area of interest by means of a limited acquisition of data can therefore be observed using the monitoring method, which would be, for example, insufficient to generate a 4D image but sufficient to detect any possible changes in geophysical property. Therefore, the software resources and the time required to process useful geophysical data are significantly reduced. Moreover, and in particular the projection model built does not change over time, that is to say, once created, it can be reused over time.

Advantageously, the monitoring method comprises, after the creation of the first set of monitoring geophysical data:
the extraction of a second image from the first image, the second image corresponding to the neighbourhood of the point of interest;
a construction of a second projection model from the first set of useful reference geophysical data and the second image, the second projection model is a result of a segregation of geophysical data, to extract useful geophysical data used while the second image is being generated in the neighbourhood of the point of interest.
the creation of a second set of useful reference geophysical data (Bi) by applying a second projection operator to the first set of useful reference geophysical data, the second projection operator is configured so that the second correlation coefficient between the second reference set of useful geophysical data obtained and the second projection model is greater than 0.7;
the creation of a second set of useful monitoring geophysical data, by applying the same projection operator obtained from the second projection model, to the first set of useful monitoring geophysical data;
a comparison of the second set of useful reference geophysical data and the second set of useful monitoring geophysical data to identify an evolution of the subsurface to be monitored.

In such a configuration, the quality of the analyses produced by the application of such projection models is significantly improved.

Advantageously, at least one new iteration of the acquisition of raw geophysical data that forms the third subset and the following steps are completed over time. Thus, an evolution of the geophysical structure over regular or irregular calendar date intervals can be observed, for example, from several weeks to several months.

Advantageously, the minimal number of useful geophysical data is equal to one recording. In such a configuration, the volume of data to be processed is significantly less, which cuts down on the resources required to monitor an area of interest of a subsurface. In view of this, the recording is, for example, selected by means of a method of inverse ray tracing from the point of interest to identify the source position and representative receivers of the point of interest, which have generated the recording of the first subset.

Advantageously, the raw geophysical data are recordings of seismic waves and the useful geophysical data are reflected, surface, or refracted seismic waves.

Advantageously, the acquisition of previous seismic wave data is a 2D, 3D, or 4D acquisition and the acquisition of raw geophysical data used to form the third subset is another 4D acquisition.

Advantageously, the projection on the projection model comprises at least:
a deconvolution and/or frequency filtering of geophysical data;
a segregation of geophysical data by applying a slope filter defined in the time-distance plane and/or in the frequency-wavenumber plane;
a static and dynamic correction of geophysical data.

In such a configuration, any predefined set of standard physical processing, single-channel or multi-channel, can be part of the projection model.

### BRIEF DESCRIPTION OF THE DRAWINGS

The invention will be understood better after reading the following description, given solely by way of an example, and with regard to the annexed drawings given as non-limiting examples, wherein identical references are given to similar objects and on which:

FIG. 1 is a flowchart describing the steps of a method to monitor a subsurface that has to be observed according to the first embodiment of the invention;

FIG. 2 is a flowchart describing the steps of a method to monitor a subsurface that has to be observed according to another embodiment of the invention;

FIG. 3 is a diagram illustrating a subset of raw geophysical data;

FIG. 4 is a diagram illustrating the projection model built using the set of raw geophysical data from the [FIG. 3];

FIG. 5 is a diagram illustrating a recording obtained by reducing the subset of the diagram from [FIG. 3] to which signal processing operations are successively applied;

FIG. 6 is a collection of diagrams comparing a single recording of the projection model of [FIG. 4] and the recording of the [FIG. 5] post-processing;

FIG. 7 is a diagram illustrating a subset of raw geophysical data along with a plurality of acquisitions, which each forma subset of raw geophysical data, each acquisition is made at a different calendar period;

FIG. 8 is a diagram illustrating a set of useful reference geophysical data as well as a plurality of useful monitoring geophysical data sets obtained by applying the first projection model on the data from [FIG. 7];

FIG. 9 is a diagram illustrating the detections of the waves arrivals differences compared with the data from [FIG. 8] at the point of interest;

FIG. 10 is a diagram illustrating a third set of useful geophysical data obtained by applying the second projection model on the data from [FIG. 8].

It should be noted that the figures outline the invention in detail so that it can be implemented; although they are not limiting, these figures are mainly used to define the invention better whenever it is necessary.

### DETAILED DESCRIPTION

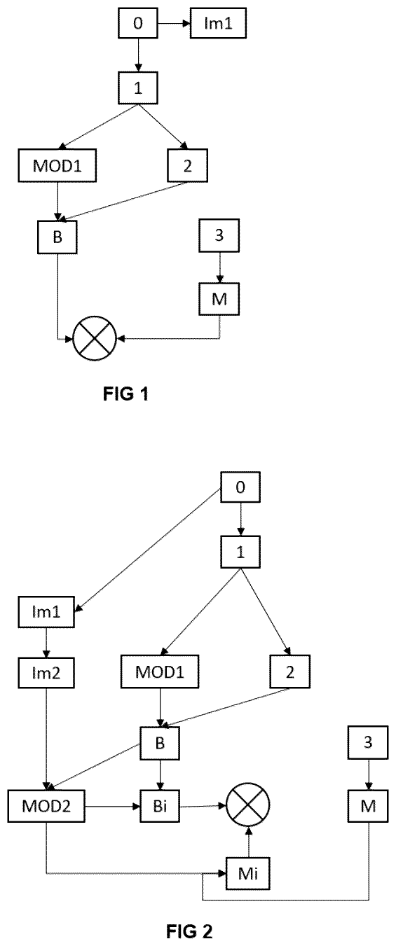

The invention concerns a method to monitor at least one area of interest of a subsurface that has to be observed comprising a point of interest and a neighbourhood of this point of interest by means of a geophysical method. In the illustrated embodiment shown in [FIG. 1]; the monitoring method is specifically implemented by means of the seismic method, any other geophysical method is applicable.

The «neighbourhood” of the point of interest is defined as being an area that corresponds to the resolution of the image generated by the geophysical method used at the point of interest. For example, if the geophysical method is a seismic method, usually the resolution might be at the quarter of the wavelength, the wavelength being a function of the wave propagation speed in the geological formations and the dominant frequency of the recorded signal.

The description given hereinafter focuses on explaining the monitoring method step by step according to the first embodiment of [FIG. 1]. The method comprises a first step of extracting the first subset 1 of raw geophysical data associated with the neighbourhood of the point of interest, among a set 0 of raw geophysical data acquired previously, and processed beforehand to generate the first previous image Im1 of the subsurface to be monitored.

With regard to the term “previously,” it is defined as being the set 0 of raw geophysical data that has already been used to generate the first image Im1 of the subsurface during an imaging process, for example, 2D or 3D. With regard to the “2D or 3D,” it is defined as being imaging performed according to two or three spatial dimensions. So, although the set 0 of raw geophysical data exists in a version that has already been processed, by means of signal processing operations, the aforesaid set 0 is used within the framework of the method in an unprocessed version, for example stored on a storage medium.

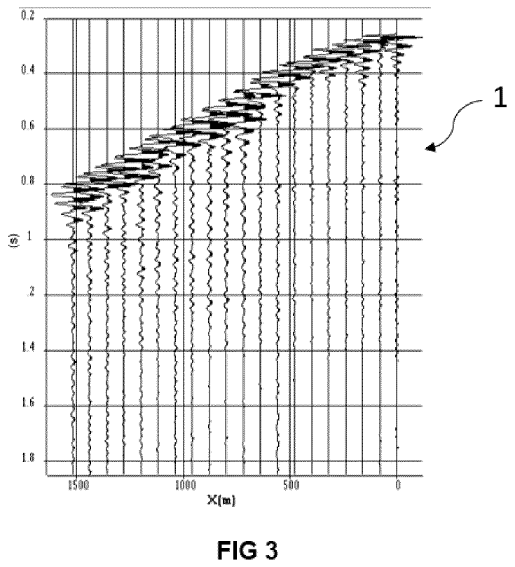

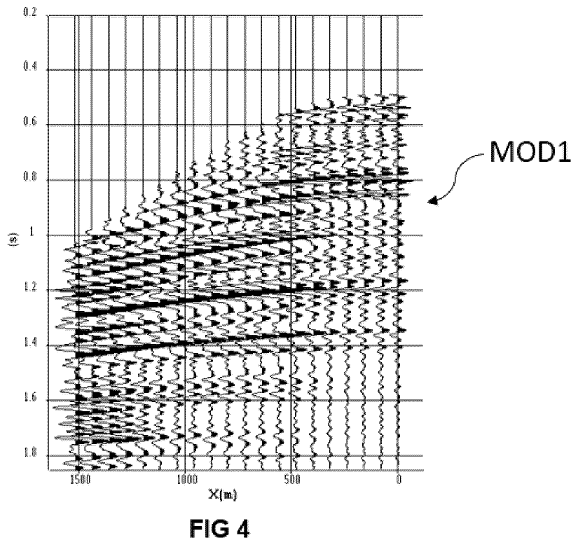

The subset 1 of raw geophysical data illustrated in [FIG. 3]. comprises at least the raw geophysical data that, when previously processed, contributed to a part of the first image Im1 comprising the point of interest and its neighbourhood. In the described embodiment, the subset 1 is a grouping of raw 2D seismic recordings. The term “2D” is defined as being a recording according to two spatial coordinates.

The method further comprises a step of building the first projection model MOD1 from the first subset of data 1, the first projection model MOD1 obtained from a segregation of geophysical data, to extract useful geophysical data used while the first image Im1 is generated in the neighbourhood of the point of interest. A projection model is a geophysical model, in this case, a seismic model helps improve the quality of a subset of raw geophysical data to such an extent that an area of interest can be monitored by enabling useful geophysical data.

To create the first projection model MOD1, single-channel processing is used first, for example, direct arrivals and/or a deconvolution and/or a frequency filtering is suppressed. Optionally, multi-channel processing is used after the single-channel processing(s). The multi-channel processing may, for example, comprise a normal moveout correction, referred to in English by the person skilled in the art as “normal moveout correction,” filtering in the frequency plane, filtering in the frequency-wavenumber plane, filtering in the frequency-distance plane, or a singular value decomposition or any known multi-channel signal processing method of the state of the art. As for a seismic method, the first projection model built comprises useful geophysical data, that is to say, useful to generate the first image Im1, for example, recordings of reflected seismic waves, as illustrated in [FIG. 3]. Alternatively, the geophysical data can be refracted seismic waves or surface seismic waves. The first projection model MOD1 is stored, for example, on a storage medium for when the method is implemented later on.

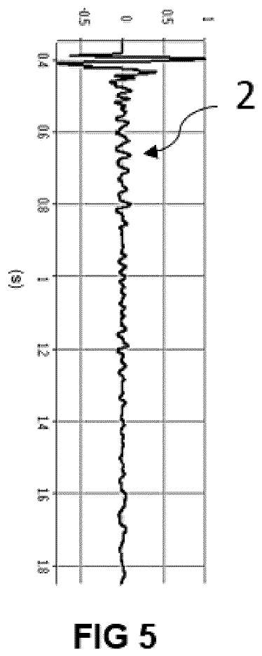

The method further comprises a step of reducing the first subset 1 of data to a second subset 2 comprising a predetermined minimal number of raw geophysical data. In the aforesaid embodiment, the minimal number of geophysical data is a single recording, commonly referred to as “trace” by the person skilled in the art, as illustrated in [FIG. 5]. Here, the recording is, for example, selected by means of a method of inverse ray tracing from the point of interest to identify the position of the source set and representative receivers of the point of interest, which have generated the recording of the first subset 1.

The method further comprises a step of creating the first reference set of useful geophysical data B by applying the first projection model MOD1 to the second subset 2. This operation is known as a “projection” of the second subset 2 on the first projection model MOD1. The projection might, for example, be carried out from a first projection operator, to improve the quality of the recording obtained during the previous step of inverse ray tracing. The first projection operator improves the quality and relevance of the recordings, by processing them so that the first set of useful geophysical data B tends towards the first ideal projection model MOD1. The term “tend,” is defined as being the first projection operator that is built from a combination of conventional signal processing techniques, to obtain a target correlation coefficient between the first reference set of useful geophysical data B and the first projection model MOD1. In other words, the correlation coefficient between the first reference set of useful geophysical data B and the first projection model MOD1 is greater than a predefined threshold, specifically 0.7. So, the projected second subset 2 “resembles” the first projection model.

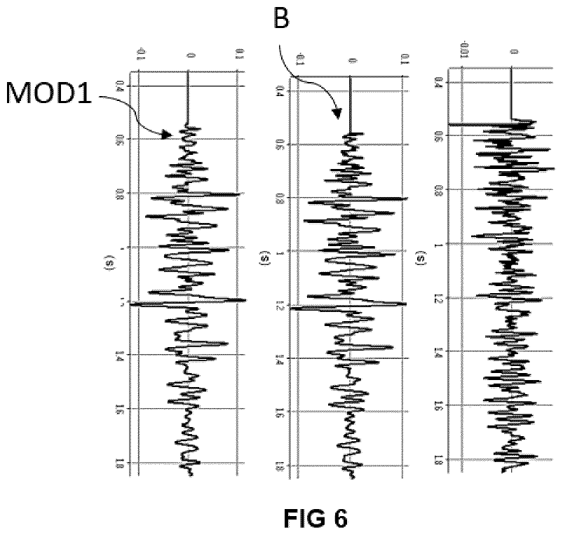

FIG. 6 illustrates successively, from left to right, the first projection model MOD1, the first reference set of useful geophysical data B, a comparison of the first projection model MOD1 and the reference geophysical data set B. Here, a correlation coefficient between the first projection model MOD1 and the reference geophysical data set B is calculated and it is considered to be very high, that is to say, greater than 0.99. Advantageously, the first correlation coefficient is greater than or equal to 0.7.

The method further comprises a step of acquiring raw geophysical data to form a third subset of raw geophysical data 3 comprising the same minimal number of raw geophysical data as the second subset 2, each piece of data from the third subset 3 is similar to a piece of data from the second subset two. With regard to the term “similar,” it is understood that the third subset of raw geophysical data 3 is obtained from an acquisition, which enables the monitoring of the same point of interest or its neighbourhood as the point of interest and the second subset of raw geophysical data 2.

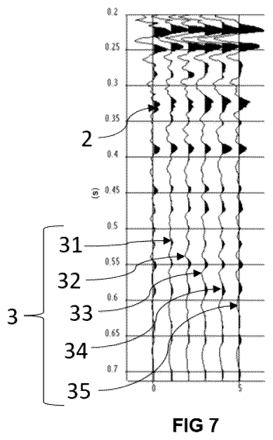

Advantageously, at least one new iteration of the acquisition of raw geophysical data that forms the third subset 3 is carried out over time. [FIG. 7]. illustrates a group on the same diagram of the second subset 2, located at position zero, designated calendar reference date, as well as five subsets 3 acquired on different calendar dates 31, 32, 33, 34 35, a process referred to in English as “Monitoring spot gathers” or “MSG.” The acquisitions can be made at regular or irregular intervals over time.

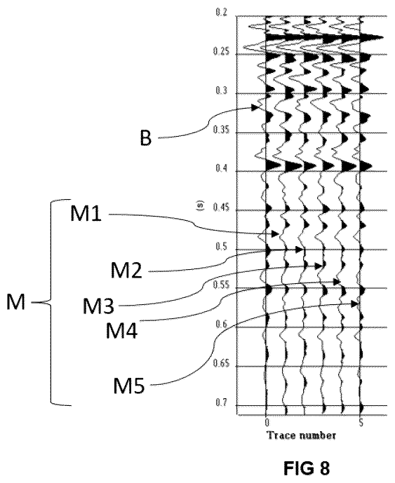

The method further comprises the creation of the first set of useful monitoring geophysical data M by applying it to the third subset 3 of the same first projection operator obtained from the first projection model MOD1. In the case where the acquisition of the third subset 3 is iterated over time, each third subset 3 is projected on the first projection model MOD1 in the same way as the subset of raw geophysical data 2 was previously projected on the first projection model MOD1, using the first projection operator. [FIG. 8]. illustrates an MSG of the reference geophysical data set B located at position zero, as well as five sets of useful monitoring geophysical data M acquired on different calendar dates M1, M2, M3, M4, M5. Acquisitions can be made at regular or irregular intervals over calendar time.

The method further comprises a comparison of the first reference set B and the first monitoring set M to identify an evolution of the subsurface to be monitored. When there is a plurality of useful monitoring geophysical data sets M, each monitoring set is compared one by one with the base reference set. In such a configuration, an evolution of the geophysical response of the area of interest through a limited acquisition of data can be observed using the monitoring method, which would be, for example, insufficient to generate a 4D image but sufficient to detect any possible changes in geophysical property. Therefore, the software resources and the time required to process useful geophysical data are significantly reduced.

Advantageously, several comparisons using different theoretical models can be made. [FIG. 9]. illustrates a measurement of a temporal drift between the reference geophysical data set B and a plurality of useful monitoring geophysical data sets M acquired on different dates. For each date, a calculation difference of the time of arrival dDT of the seismic echo of the point of interest between the useful reference geophysical data set B and each of the useful monitoring geophysical data sets M is calculated with an associated uncertainty that depends on the signal-to-noise ratio and the bandwidth known by the person skilled in the art.

The description hereinafter focuses on describing the invention according to another embodiment, illustrated in [FIG. 2]. In this embodiment, the monitoring method further comprises, after the creation of the first set of useful monitoring geophysical data M:
the extraction of the second image Im2 from the first image Im1, the second image Im2 corresponding to the neighbourhood of the point of interest;
the construction of the second projection model MOD2 from the first set of useful reference geophysical data B and the second image Im2, the second projection model MOD2 is obtained from a segregation of geophysical data, to extract useful geophysical data used while the second image Im2 is being generated in the neighbourhood of the point of interest;
the creation of the second set of useful reference geophysical data Bi by applying a second projection operator to the first set of useful reference geophysical data B, the second projection operator is configured so that a second correlation coefficient between the second reference set of useful geophysical data Bi obtained and the second projection model MOD2 is greater than 0.7;
the creation of a second set of useful monitoring geophysical data Mi, by applying the same projection operator obtained from the second projection model MOD2, to the first set of useful monitoring geophysical data M;
a comparison of the second set of useful reference geophysical data Bi and the second set of useful monitoring geophysical data Mi to identify an evolution of the subsurface to be monitored.

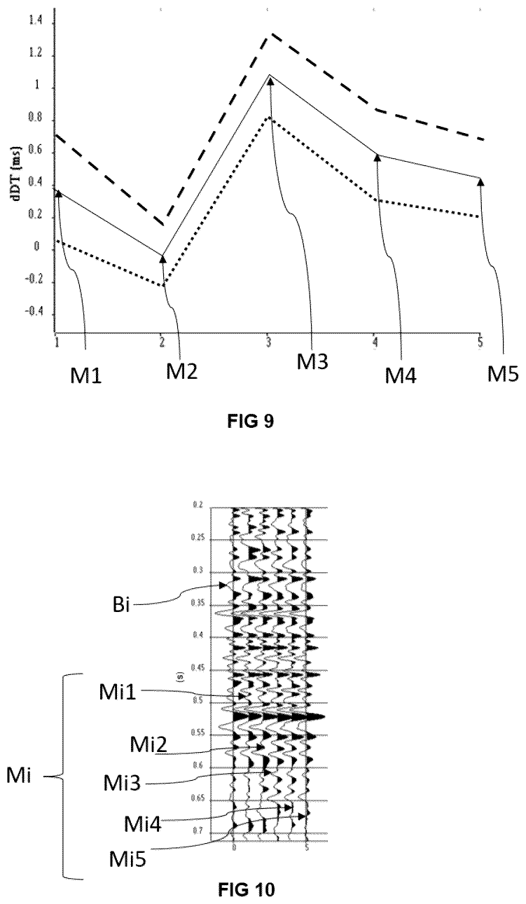

The second projection operator improves even more the quality and relevance of the recordings by processing them, so that the second set of useful geophysical data Bi tends towards the second ideal projection model MOD2. With regard to the term “tend,” it is defined as being the second projection operator that is built from a combination of conventional signal processing techniques, to obtain the second target correlation coefficient between the second reference set of useful geophysical data Bi and the second projection model MOD2. The second operator is configured so that the second target correlation coefficient obtained is greater than 0.7.

[FIG. 10]. illustrates an MSG of the second set of useful reference geophysical data Bi located at the calendar reference position, as well as five second sets of useful monitoring geophysical data Mi acquired on different dates Mi1, Mi2, Mi3, Mi4, Mi5. From this MSG, the analyses can then be carried out, to draw conclusions on the evolution of the geophysical structure of the area of interest over time, in particular measurements of temporal drifts that are similar to those made for the embodiment depicted in [FIG. 9].

It should also be noted that the invention is not limited to the aforementioned embodiments. Indeed, the person skilled in the art will know that various modifications can be made to the aforesaid embodiment, in light of the information that they have been provided with.

In the aforesaid detailed presentation of the invention, the terms used should not be interpreted as limiting the invention to the embodiment described herein, it must be interpreted so that any equivalent foreseen by the person skilled in the art can be included when they apply their general knowledge and the information that they have just been provided with.

1-7. (canceled)

8. Method to monitor at least one area of interest of a subsurface to be observed comprising a point of interest and a neighborhood of the aforesaid point of interest, comprising:
an extraction of the first subset (1) of raw geophysical data associated with the neighbourhood of the point of interest, among a set (0) of raw geophysical data acquired previously, and processed beforehand to generate the first previous image (Im1) of the subsurface to be monitored;
a construction of a first projection model (MOD1) from the first subset of data (1), the first projection model (MOD1) resulting from a segregation of geophysical data, to extract useful geophysical data used while the first image (Im1) is being generated in the neighbourhood of the point of interest; and
a reduction of the first subset (1) of data to the second subset (2) comprising a predetermined minimal number of raw geophysical data;
the creation of a first reference set of useful geophysical data (B) by applying the first projection operator to the second subset (2), the first projection operator being configured so that a first correlation coefficient between the first reference set of useful geophysical data (B) obtained and the first projection model (MOD1) is greater than 0.7;
an acquisition of raw geophysical data that forms a third subset of raw geophysical data (3) comprising the same minimal number of raw geophysical data as the second subset (2), each piece of data from the third subset (3) corresponding to a piece of data from the second subset (2);
the creation of the first set of useful monitoring geophysical data (M), by applying the same first projection operator from the first projection model (MOD1), to the third subset (3); and
a comparison of the first reference set (B) and the first monitoring set (M) to identify an evolution of the subsurface to be monitored.

9. The method to monitor according to claim 8, after the creation of the first set of geophysical monitoring data (M), further comprise:
the extraction of a second image (Im2) from the first image (Im1), the second image (Im2) corresponding to the neighborhood of the point of interest;
a construction of a second projection model (MOD2) from the first set of useful reference geophysical data (B) and the second image (Im2), the second projection model (MOD2) obtained from a segregation of geophysical data, to extract useful geophysical data used while the second image (Im2) is being generated in the neighbourhood of the point of interest
the creation of a second set of useful reference geophysical data (Bi) by applying the second projection operator to the first set of useful reference geophysical data (B), the second projection operator is configured so that a second correlation coefficient between the second reference set of useful geophysical data (Bi) obtained and the second projection model (MOD2) is greater than 0.7;
the creation of a second set of useful monitoring geophysical data (Mi), by applying the same projection operator obtained from the second projection model (MOD2), to the first set of useful monitoring geophysical data (M);
a comparison of the second set of useful reference geophysical data (Bi) and the second set of useful monitoring geophysical data (Mi) to identify an evolution of the subsurface to be monitored.

10. The method to monitor according to claim 9, wherein at least one new iteration of the acquisition of raw geophysical data that forms the third subset (3) and the following steps are carried out over time.

11. The method to monitor according to claim 8, wherein the minimal number of useful geophysical data is equal to one recording.

12. The method to monitor according to claim 8, wherein the raw geophysical data are recordings of seismic waves and the useful geophysical data are reflected, surface, or refracted seismic waves.

13. The method to monitor according to claim 12, wherein the acquisition of previous seismic wave data is a 2D, 3D, or 4D acquisition and the acquisition of raw geophysical data used to form the third subset (3) is another 4D acquisition.

14. The method to monitor according to claim 8, wherein the application of the first projection model (MOD1) comprises at least:
a deconvolution or frequency filtering of geophysical data;
a segregation of geophysical data by applying a slope filter defined in the time-distance plane and/or in the frequency-wavenumber plane;
a static and dynamic correction of geophysical data.

15. The method to monitor according to claim 9, wherein the minimal number of useful geophysical data is equal to one recording.

16. The method to monitor according to claim 12, wherein the raw geophysical data are recordings of seismic waves and the useful geophysical data are reflected, surface, or refracted seismic waves.

17. The method to monitor according to claim 12, wherein the application of the first projection model (MOD1) comprises at least:
a deconvolution or frequency filtering of geophysical data;
a segregation of geophysical data by applying a slope filter defined in the time-distance plane and/or in the frequency-wavenumber plane;
a static and dynamic correction of geophysical data.
